(19) United States
(12) Patent Application Publication
(10) Pub. No.: US 2016/0052258 A1
(43) Pub. Date: Feb. 25, 2016

(54) METHOD AND DEVICE FOR PRINTING ON A SUBSTRATE

(71) Applicant: WINDMOELLER & HOELSCHER KG, Lengerich (DE)

(72) Inventors: Franz DURST, Langensendelbach (DE); Martin GILLERT, Erlangen (DE)

(21) Appl. No.: 14/780,824

(22) PCT Filed: Mar. 28, 2014
(86) PCT No.: PCT/EP2014/056307

§ 371 Date: Sep. 28, 2015

(30) Foreign Application Priority Data
Mar. 28, 2013 (DE) 10 2013 205 678.8
Apr. 12, 2013 (DE) 10 2013 206 588.4

(51) Int. Cl. B41F 31/18; B41F 16/00

(52) U.S. Cl. CPC B41F 31/18; B41F 16/00

(57) ABSTRACT

The invention relates to a method for printing on a substrate (1) by means of a fluid (F) that can be used for printing, in particular a printing ink, comprising the following steps: conveying the fluid (F) to a slotted nozzle tool (4), applying a fluid film produced by means of the slotted nozzle tool (4) to a rotating transfer roller (5), transferring the fluid (F) from the transfer roller (5) to a rotating printing roller (6), which is in contact with the transfer roller and has a printing plate (7), and printing the fluid (F) from the printing plate (7) onto the substrate (11)

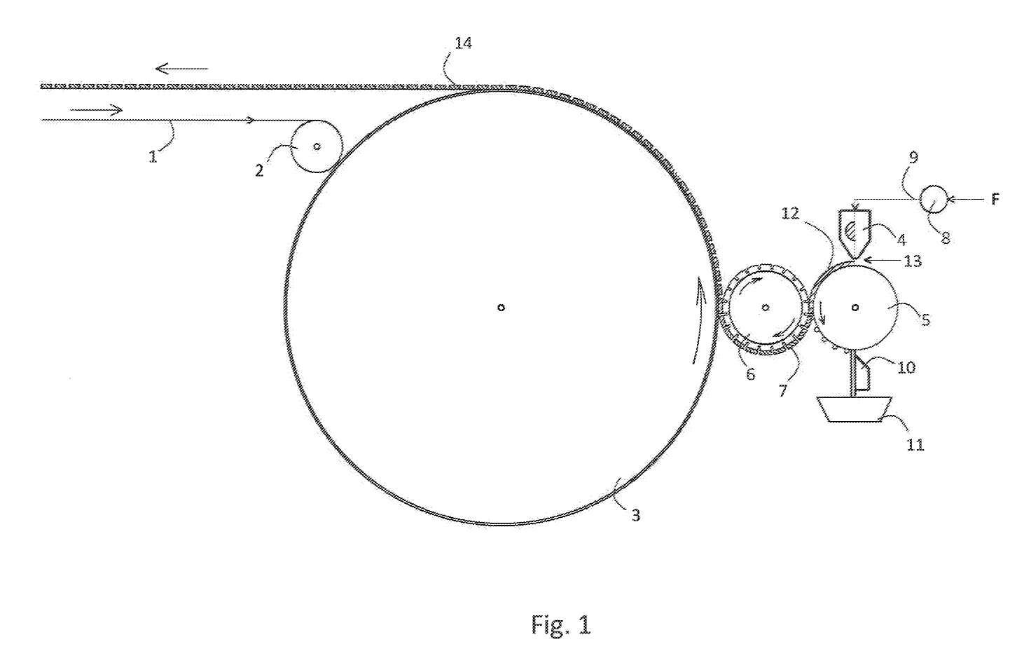

The invention relates to a method and a device for printing a substrate with a printable fluid, particularly with ink.

According to prior art, the so-called “flexoprinting method” is known. Here, ink is initially applied to an anilox roll. At a surface of the anilox roll approximately 60 to 500 cup-shaped recesses are provided per cm² to receive the ink. The ink present in these recesses is then transferred to a plate and/or a printing block, which is received by a printing cylinder. The ink is finally printed from the printing block to the substrate guided via a backing cylinder. The thickness of the ink film transferred to the substrate depends on the depth, number, and design of the recesses at the service of the anilox roll.—In order to adjust the desired hue it is necessary to select, from a plurality of anilox rolls provided, one that is suitable for the ink to be printed and subsequently to change the hue and/or the viscosity of the ink used until the desired hue is achieved. For this purpose it may also be necessary to try different anilox rolls. This is time-consuming and expensive. Additionally, the surface of the anilox rolls is sensitive to damages, which disadvantageously appear in the printed image.

The objective of the present invention is to correct the disadvantages of prior art. In particular, a method and a device shall be provided which allows printing a substrate with lower expenses, According to another purpose of the invention the method and the device shall allow a simplified adjustment of the thickness of the fluid film to be printed on the substrate.

This objective is attained by the features [sic] 1 and 10. Beneficial embodiments of the invention are discernible from the features of claims 2 to 9 and 11 to 18.

According to the invention a method is suggested for printing a substrate with a printable fluid, particularly ink, showing the following steps:

Conveying the fluid to a slot nozzle tool,

Applying a fluid film generated via a slot nozzle tool onto a rotating transfer roll,

Transferring the fluid from the transfer roll to a rotating printing roll contacting it and showing a printing plate, and

Printing the fluid from the printing plate onto the substrate.

By here using a combination of a slot nozzle tool with a transfer roll according to the invention, instead of a conventional combination of an ink applicator with an anilox roll, the provision of a plurality of different anilox rolls can be waived. A desired thickness of a fluid film printed on the substrate can for example be varied by changing the flow rate of the fluid through a slot nozzle of the slot nozzle tool and/or by a change of the speed of rotation of the transfer roll. This way it is possible, without any major expense, to adjust the desired hue of an ink printed onto a substrate. The selection and a change of anilox rolls are no longer necessary for this purpose. This way the expense for printing a substrate can be considerably reduced.

In the sense of the present invention, a “slot nozzle tool” is understood as a tool by which a fluid film can be generated showing a predetermined thickness over the width of the slot nozzle. Such a slot nozzle tool is known for example from WO 2010/020594. In order to allow the fluid film to form, the slot nozzle is arranged at a predetermined distance from a surface to be coated, here the surface of the transfer roll. Such a distance may range from 50 μm to 40.0 cm.

In the sense of the present invention, the term “fluid” is here understood as a liquid that can be printed in a printing process onto a substrate. In particular, this may represent an ink or a fluid for the generation of organic semiconductors.

The term “substrate” is generally understood as a material, which shows a printable, preferably level surface. The substrate may comprise a web-shaped material made from paper, plastic, or a textile. The substrate may also represent an objective unit. The substrate may for example also be made from glass, corrugated cardboard, cardboard, or metal.

The “printing plate” may represent a plate, which allows letterpress or gravure printing.

According to an advantageous embodiment of the invention the width of the slot nozzle of the slot nozzle tool is adjusted such that a thickness of the fluid film applied to the transfer roll is provided in a predetermined range over the width of the transfer roll. The thickness of the fluid film ranges advantageously from 0.2 μm to 2.0 mm, preferably from 1 μm to 500 μm. By varying the thickness of an ink film applied on the transfer roll the hue can be adjusted.

According to another advantageous embodiment a thickness of the fluid film applied on the transfer roll is controlled via a conveying device provided to convey the fluid, e.g., a pump or a pressure vessel. With the conveyer device a flow rate can be varied of the fluid discharged through the slot nozzle. Further, the thickness of the fluid film can be varied by the speed of rotation of the transfer roll. This also allows, for example, a simple and fast adjustment of a hue.

The fluid is supplied to the slot nozzle tool via at least one supply channel, and from there through a plurality of slot nozzles, extending fan-shaped, to the distribution channels, with a cross-section of the distribution channels increasing from the supply channel to the slot nozzle. The provision of the distribution channels, extending fan-shaped to the slot nozzle as well as their widening cross-sections, results in the ink essentially being subjected to the same pressure at the slot nozzle over the entire width of said slot nozzle. This way, over the entire width of the slot nozzle, the generation of a fluid film can be achieved showing an essentially constant thickness. Consequently, the thickness of the fluid film applied via the transfer roll also shows an essentially constant thickness over its width. This way, a homogenous printing quality can be ensured over the entire width of the substrate to be printed.

According to an advantageous embodiment of the invention, downstream in reference to a contact area between the transfer roll and the printing roll, any fluid remnants adhering to the transfer roll are removed and fed to a collection tank. The fluid remnants on the transfer roll cover those areas which have not been transferred to the printing plate. In order to remove the fluid remnants, for example at least one doctor blade can be used contacting the transfer roll.

According to another advantageous embodiment the substrate is pressed via a rotating backing roll against the printing roll. In this case a flexible web-shaped material is used as the substrate, for example a plastic film, a paper web, a textile web, or the like.

The backing roll is beneficially driven, i.e. the substrate can be transported simultaneously to the backing roll.

According to another advantageous embodiment of the invention the substrate printed with fluid is dried. For this purpose, downstream in reference to the printing roll a drying device may be provided.

According to another aspect of the invention a device is suggested for printing a substrate with a printable fluid, particularly ink, showing

A slot nozzle tool for generating and applying a fluid film on a rotational transfer roll,

A rotational printing roll, showing a printing plate being in contact with a transfer roll for printing the fluid, transferred by the transfer roll to the printing plate, on a substrate pressed against it.

The suggested device allows for example in case of ink being used a simple adjustment of the hue. Here, it is not necessary to exchange the transfer roll, for example. A thickness of the fluid film applied on the transfer roll via a slot nozzle tool can be adjusted by changing the flow rate through the slot nozzle and/or changing a speed of rotation of the transfer roll.

Advantageously a device is provided to adjust the width of the slot nozzle of the slot nozzle tool. The selection of a suitable width of the slot nozzle depends on the fluid. If the fluid comprises pigments, for example, the width of the slot nozzle is adjusted such that it is not being clogged by pigments or pigment agglomerates. The device for adjusting the width of the slot nozzle may represent a manually operated device, however particularly also an electrically operated device. A thickness of the fluid film applied on the transfer roll can be measured over the width of the transfer roll using a measuring device. Depending on the measurements provided by the measuring device the flow rate of the fluid can also be automatically controlled by the slot nozzle using suitable control measures, so that a fluid film with a homogenous thickness is applied over the width of the transfer roll. Additionally, the thickness of the fluid layer can also be adjusted overall.

According to another embodiment a conveyance device is provided for conveying the fluid film to the slot nozzle tool. The conveyance device shall beneficially be embodied such that this way the fluid can be conveyed to the slot nozzle tool with a variable flow rate. The flow rate generated with the conveyance device can be controlled or regulated depending on a thickness of the fluid film applied on the transfer roll.

In order to generate and apply the fluid film a conventional slot nozzle tool may be used, by which a fluid film can be generated with a homogenous thickness over the width of the transfer roll. Such a slot nozzle tool is known for example from WO 20101020594 A1, with its disclosed content hereby being included.

According to another embodiment of the device, downstream in reference to a contact area between the transfer roll and the printing roll a doctor blade is provided for removing any fluid remnants still adhering to the transfer roll.

Downstream in reference to the doctor blade a collection tank may be provided for collecting the fluid removed by the doctor blade from the transfer roll.

According to another particularly advantageous embodiment of the invention a backing roll is provided for pressing the substrate against the printing roll and/or the printing plate. In this case, the web-shaped substrate is guided over the backing roll, and thus pressed against the printing roll so that the fluid is transferred from the printing plate to the substrate. A device for driving the backing roll may be provided. In this case the backing roll simultaneously serves as a transportation roll.

A device for drying the substrate printed with the fluid may be provided downstream in reference to the printing roll.

In the following an exemplary embodiment of the invention is explained in greater detail based on the drawing.

The only FIGURE shows schematically a device for printing a substrate 1 rolled off a storage roll (not shown here). The substrate 1 may represent a plastic film, a paper web, a textile web, or the like, for example. The reference character 2 indicates a deflection roll, by which the substrate 1 is forced to contact the backing roll 3. The reference character 4 indicates a slot nozzle tool, which is arranged above the surface of the transfer roll 5.

The transfer roll 5 may be produced from metal. The surface of the transfer roll 5 is advantageously embodied in a smooth fashion. It may show an average surface parameter Ra of maximally 0.5 preferably maximally 0.3 μm, particularly preferred maximally 0.1 μm. The surface of the transfer roll 5 may also be embodied in a rough fashion. It may be produced from an elastic, plastic, rubber, metal, or ceramic.

The transfer roll 5 is provided contacting a rotational printing roll 6, arranged parallel in reference thereto, with a printing plate 7 being provided at its surface. The printing roll 6 in turn contacts the backing roll 3 arranged parallel in reference thereto. The reference character 8 indicates a pump, which is connected via a line 9 for supplying a fluid F to the slot nozzle tool 4.

A doctor blade 10 contacts the transfer roll 5 approximately opposite the slot nozzle tool 4. A collection tank 11 is arranged downstream in reference to the doctor blade 10.

The function of the device is as follows:

From a fluid reservoir (not shown in greater detail here) via the pump 8, the fluid F is supplied through the line 9 to the slot nozzle tool 4. A fluid film is generated by the slot nozzle tool 4, which extends over the width of the transfer roll 5. The fluid film falls from the slot nozzle 13 onto the surface of the transfer roll 5 and here leads to a fluid film 12 forming.

A thinness of the fluid film 12 can be adjusted by changing the flow rate through the slot nozzle 13 and/or by a variation of a speed of rotation of the transfer roll 5. The fluid film 12 is subsequently transferred to the printing plate 7, mounted on the surface of the printing roll 6. Remaining fluid remnants are removed via the doctor blade 10 from the transfer roll 5 and fed to the collection tank 11. The fluid film 12 transferred to the printing plate 7 is finally printed to the substrate 1, fed by the backing roll 3. The reference character 14 indicates the printed substrate, which after the printing process may be transported to a drying device (not shown here in greater detail).

### LIST OF REFERENCE CHARACTERS

1 Substrate
2 Deflection roll
3 Backing roll
4 Slot nozzle tool
5 Transfer roll
6 Printing roll
7 Printing plate
8 Pump
9 Line
10 Doctor blade
11 Collection tank
12 Fluid film
13 Slot nozzle
14 Printed substrate
F Fluid
Ra Surface parameter value

1. A method for printing a substrate (1) with a printable fluid (F), particularly ink, showing the following steps:
Conveying the fluid (F) to a slot nozzle tool (4),
Applying a fluid film generated via the slot nozzle tool (4) on a rotating transfer roll (5),
Transferring the fluid (F) from the transfer roll (5) to a printing roll (6) being in contact therewith and comprising a printing plate (7), and
Printing the fluid (F) from the printing plate (7) to the substrate (1).

2. A method according to claim 1, with a width of the slot nozzle (13) of the slot nozzle tool (4) being adjusted such that a thickness of a fluid film (12) transferred to the transfer roll (5) being within a predetermined range over a width of the transfer roll (5).

3. A method according to claim 1, with a thickness of the fluid film (12) applied on the transfer roll (5) being controlled via a conveyance device (8) provided to convey the fluid (F).

4. A method according to claim 1, with the fluid (F) being supplied to the slot nozzle tool (4) via at least one supply channel, and from there being conveyed through a plurality of distribution channels extending fan-shaped to the slot nozzle (13), with a cross-section of the distribution channels increasing from the supply channel to the slot nozzle (13).

5. A method according to claim 1, with downstream in reference to a contact area between the transfer roll (5) and the printing roll (6) any fluid remnants still adhering at the transfer roll (5) being removed and fed to a collection tank (11).

6. A method according to claim 1, with a doctor blade (10) being used to remove the fluid remnants, contacting the transfer roll (5).

7. A method according claim 1, with the substrate (1) being pressed with a rotating backing roll (3) against the printing roll (6).

8. A method according to claim 1, with the backing roll (3) being driven.

9. A method according to claim 1, with the substrate (14) printed with the fluid (F) being dried.

10. A method for printing a substrate (1) with a printable fluid (F), particularly ink,
comprising a slot nozzle tool (4) for generating and applying a fluid film on a rotational transfer roll (5),
a rotational printing roll (6) contacting the transfer roll (5) and showing a printing plate for printing fluid (F), transferred from the transfer roll to the printing plate (7), to a substrate (1) pressed against it.

11. A device according to claim 10, with the device being provided for adjusting a width of the slot nozzle (13) of the slot nozzle tool (4).

12. A device according to claim 10, with the conveyance device (8) being provided for conveying the fluid (F) to the slot nozzle tool (4).

13. A device according to claim 10, with a control being provided for adjusting the flow rate of the fluid (F) conveyed with the conveyance device (8) to the slot nozzle tool (4).

14. A device according to claim 10, with the slot nozzle tool (4) comprising a feed channel, from which a plurality of distribution channels extend to the slot nozzle (13) in a fan-shaped fashion, with a cross section of the distribution channels increasing from the supply channel to the slot nozzle (13).

15. A device according to claim 10, with, downstream in reference to a contact area between the transfer roll (5) and the printing roll (6), a doctor blade (10) being provided to remove any fluid remnants still adhering to the transfer roll (5).

16. A device according to claim 10, with the backing roll (3) being provided to press the substrate (1) against the printing (6).

17. A device according to claim 10, with the device being provided to drive the backing roll (3).

18. A device according to claim 10, with downstream in reference to the printing roll (6) a device is provided for drying the substrate (14) printed with the fluid (F).
